(19) United States
(12) Patent Application Publication
(10) Pub. No.: US 2002/0099795 A1
(43) Pub. Date: Jul. 25, 2002

(54) System and method for maintaining two-way asynchronous notification between a client and a web server

(76) Inventors: Robert Betros, San Diego, CA (US); Mansour Raad, Winchester, MA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/766,439

(22) Filed: Jan. 19, 2001

(51) Int. Cl. G06F 15/16

(52) U.S. Cl. 709/219; 709/202

(57) ABSTRACT

A system and method for maintaining direct, two-way asynchronous communication between a client and a web server. An HTTP-compliant request is communicated from a client to a web server. The HTTP request is configured to initialize a CGI that operates within or in conjunction with the web server. A task, associated with the CGI, is executed in accordance with the HTTP request. The task is configured to perform the two-way asynchronous communication with the client until terminated by the client or the CGI. The task includes an operation in which client request data is listened for and read by the CGI through the web server. The task further includes an operation in which data is created and sent by the CGI to the client through the web server.

### BACKGROUND OF THE INVENTION

1. Field of the Invention

This invention relates to computer communications, and more particularly to two-way asynchronous communications between a client and a web server.

2. Description of the Related Art

A host is a physical machine having an operating system software that manages one or more other computer programs that reside on the physical machine. A server is one type of a computer program that can reside on a host that provides services to another computer program on the same or different host. One specific type of server is a web server. A web server is a computer program that communicates with a client according, but not limited to, the hypertext transfer protocol (HTTP), an application-level protocol for distributed hypermedia systems such as the World Wide Web (the “Web” or “WWW”). As used herein, HTTP means any application-level protocol that is supported by a web server or a web browser, including but not limited to secure HTTP (HTTPS).

A web server includes the ability to execute one or more Common Gateway Interfaces (CGIs). A CGI is a software component that typically runs within or in conjunction with a web server as follows.

The client opens a socket connection to the web server and sends an HTTP-formatted request to the web server. The web server receives the request and if it has been tasked to execute a CGI, it forwards the request to the CGI. If the CGI is not already loaded and initialized to execute its operation, then it is loaded and initialized. The initialized CGI receives the HTTP request and, in response, executes its operation for performing a specific function. During this operation, HTTP responses may be composed and sent to the web server, which forwards them on to the client. Only upon conclusion of the operation, may the web server close the socket connection.

In more detail, the foregoing process can be described as follows:

The web server is pre-configured to accept client-side socket connections on a known port. The client opens a client-side component of a socket connection to the web server on that known port. The socket connection is made from the client host to the host on which the web server resides via a capability built into the operating systems of both hosts. In response to the opening of the client-side component of the socket connection, the web server creates the corresponding server-side component of the socket connection. The combination of the two socket connection components establishes a two-way communications link through which information will flow.

The client then sends the header component of an HTTP formatted request to the web server across the socket connection. The header contains information that specifies an action to be performed by the web server, such as the execution of a CGI. The web server receives and processes the header information and replies back to the client with information indicating the status of the action requested of the web server. If the action is the execution of a CGI, and if this is the first time that the CGI has been invoked, then it is first loaded and initialized before it executes. After the process has begun its execution, the client has the option of sending the body of the HTTP request to the web server, which forwards it on to the CGI.

The CGI performs its operation and may compose HTTP responses that are sent to the web server who forwards them to the client. The web server gets notified that he may close the server-side component of the socket connection upon the conclusion of the CGI's operation. Upon the closing of the server-side component of the socket connection, the client is notified and closes the client-side component of the socket connection.

For communications through a firewall, a client may only communicate to a host on ports specifically allowed by the firewall. Typically, the host with which the client wishes to communicate includes a web server configured to use a predefined and known port. The persistency of communications between a client and a web server lasts only for the duration of a single HTTP transaction. An HTTP transaction includes opening a socket connection, sending an HTTP request, executing an action, formulating HTTP responses, and sending the HTTP responses back to the client. Upon the termination of the action, the socket connection may be automatically closed.

### SUMMARY OF THE INVENTION

This invention relates to a system and method for maintaining direct, two-way asynchronous communication between a client and a web server. The invention, embodied as a method, can be accomplished within a single HTTP transaction. An embodiment of the invention includes communicating an HTTP request from a client to a web server. The HTTP request is configured to initialize a CGI that operates within or in conjunction with the web server. The embodiment further includes executing operations associated with the CGI. The operations are configured to perform the two-way asynchronous communication with the client through the web server such that the web server maintains a direct socket connection with the client. The operations are continually executed until terminated by the client or the CGI.

A direct socket connection between the client and the web server means that each is associated with a host, from which a component of the socket connection is opened.

In another embodiment of the invention, a system for maintaining two-way asynchronous communication between a client and a web server using a single HTTP transaction includes means for communicating an HTTP request from a client to a web server, where the HTTP request is configured to initialize a CGI that operates within or in conjunction with the web server. The system further includes means for executing operations associated with the CGI.

In a specific exemplary embodiment, the communicating means includes client-side logic in communication with the web server via a socket connection. In another specific exemplary embodiment, the executing means includes server-side logic, either within or in conjunction with the web server and responsive to the HTTP request, that is configured to execute the CGI. In one particular embodiment of the invention, the CGI is a servlet configured to operate within or in conjunction with the web server, and being further configured to communicate with the client-side logic.

### BRIEF DESCRIPTION OF THE DRAWINGS

FIG. 1 illustrates a system on which a process for maintaining two-way asynchronous communications may be executed.

FIG. 2 is a flow chart of a method for maintaining two-way asynchronous communication between a web server and a client.

FIG. 3 is a flow chart of a CGI according to one embodiment of the invention.

FIG. 4 is a flow chart of a method for maintaining two-way asynchronous communication between a client and a web server according to an alternative embodiment of the invention.

### DETAILED DESCRIPTION OF THE PREFERRED EMBODIMENTS

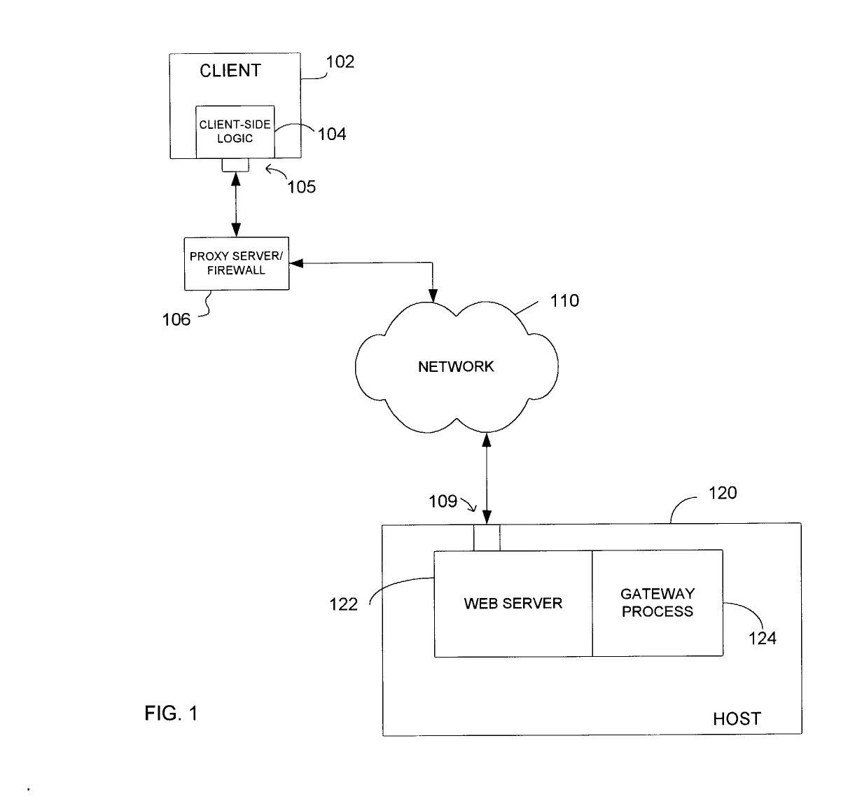

This invention provides for a system and method by which two-way asynchronous communications are maintained between a client and a web server. The invention is applicable to communications through both firewalls and proxy servers. FIG. 1 shows a communication system 100 on which the invention may be suitably employed. The system 100 is preferably a portion of the Web operating according to HTTP. However, other types of communication systems or networks are contemplated. The system 100 illustrates only one socket connection between a single client 102 and a single host 120. However, those skilled in the art will recognize that FIG. 1 is illustrative only, and that the invention is applicable in particular to communications between a large number of hosts 120 and a large number of clients 102. Further, this invention is applicable to communications between one host 120 and a plurality of clients 102.

The client 102 is a type of host, which is a physical computer platform having an operating system. The operating system is a computer program for controlling the system-level functions of the computer platform. The client 102 includes client-side logic 104. The client side logic 104 can be pre-installed on the client, or dynamically delivered to the client. Examples of dynamically delivered client-side logic include, but are not limited to, a Java™ applet and a Macromedia Shockwave movie. Other embodiments of the client-side logic, and its delivery, are possible. The client 102 is configured to access and communicate through a network 110, such as the Internet, for example. In some instances, a firewall 106 is provided between the client 102 and the network 110 for controlling communications with the client 102, and for performing security functions for the client 102.

The network 110 includes a large number of interconnected communication nodes, such as routers and servers, that collectively establish a number of communication paths, and which each may be configured to transfer HTTP-formatted packets. A communication path that is established between the client 102 and the host 120, and through the firewall 106 in some instances, is known as a socket connection. The socket connection includes a client-side component 105 and a server-side component 109. Each component of the socket connection is independently configurable, and established and terminated in a coordinated manner according to a specific protocol. A socket connection that is established through the network 1 10 to traverse a number of communication nodes, is still considered a direct connection between the client 102 and the host 120 when both the host 120 and the host on which the client resides.

The host 120 includes a web server 122 that performs a particular task in response to requests from the network 110, such as requests that originate from the client 102. These tasks include the delivery of web content or the execution of CGIs. The host 120 can include one or more CGI 124, each associated with particular operations. An embodiment of the CGI 124 can include a servlet. Other embodiments of the CGI 124 and its logical operations are also possible.

According to one embodiment of the invention, a CGI is invoked in response to an HTTP request passed from the client 102 to the web server 122 and on to the CGI. The initial HTTP request identifies to the web server, which CGI to invoke. The CGI, according to an exemplary embodiment of the invention, is configured to perform operations that include continuous, two-way asynchronous communication of data between the client 102 and the CGI.

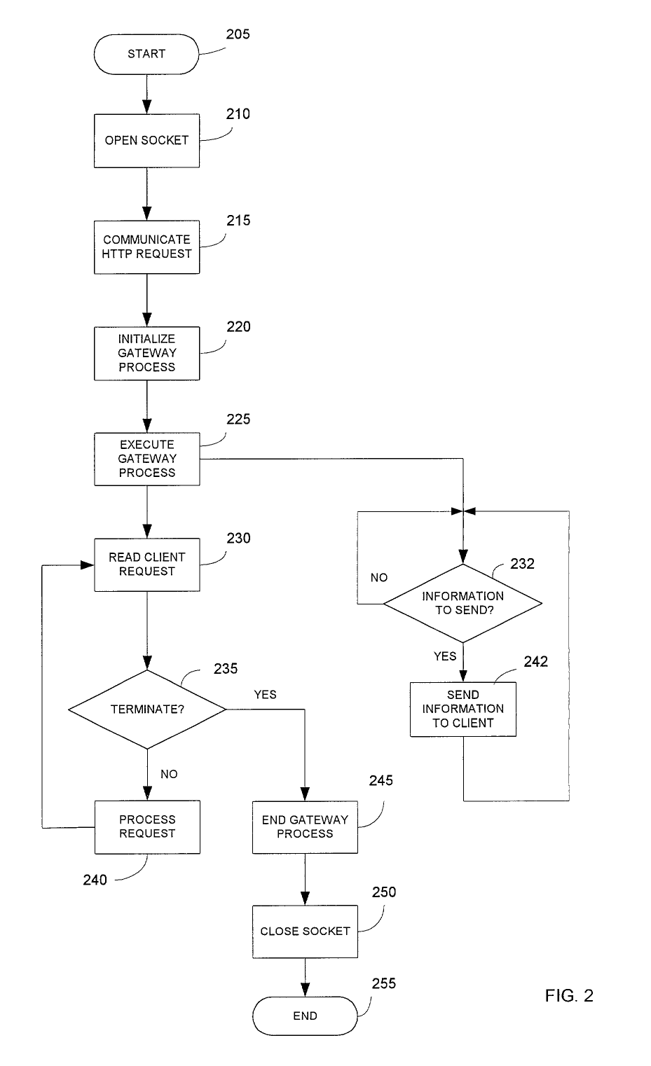

FIG. 2 shows a flow chart of a method 200 for maintaining two-way asynchronous communications over a socket connection between a client and a web server. In one particular embodiment of the invention, the process 200 is performed through a firewall. Process 200 starts at step 205. At step 210, a socket connection is opened between the client and the web server. In particular, a client opens the client-side component of the socket connection, and sends a notification to the host on which the web server is residing, which causes the web server to open the corresponding server-side component of the connection.

At step 215, an HTTP request is communicated over the opened socket connection. In a particular embodiment, the client then sends the header component of the HTTP request to the web server. The header contains information that specifies a task to be performed by the web server. According to an embodiment of the invention, the requested task is to initialize and execute a CGI, shown with reference to step 220. Once initialized, the CGI is executed at step 225. The CGI can be configured with multiple operations.

According to an embodiment of the invention, one operation of the CGI is the reading of client requests at step 230, and another operation of the CGI is the sending of information to the client at step 232. These two operations are used to perform the two-way asynchronous communication with the client. These two operations can also include the processing of information received from the client at step 240, and the creation of information to send to the client at step 242. In one particular embodiment, the information sent or received by the CGI is compliant with a protocol other than HTTP.

The second operation is illustrated in greater detail with reference to step 232, in which the CGI sends information to the client. The second operation includes the creation of information to send to the client, illustrated with reference to step 242. If there is no information to send, the second operation of the CGI waits for the creation of information to occur. When the information is available, as shown with step 242, the information is sent to the client at step 232. The second operation continually repeats until the CGI is terminated, the method for which is described below.

Referring again to step 230, in which the CGI reads client requests, a determination is made at step 235 whether the client request is a termination request. If no termination request is received, the information received in the request is processed by the first operation of the CGI at step 240. If a client request includes a termination request, the CGI ends at block 245. When the CGI ends, the second operation of the CGI is terminated accordingly.

In an exemplary embodiment, the task of performing two-way asynchronous communication is accomplished within a single HTTP transaction. According to HTTP standards, a single HTTP transaction should be a persistent communication with a client until the transaction is complete, unless the web server is notified otherwise. Thus, in accordance with the invention, the CGI will continue until notified by the client. At step 250, upon termination of the CGI, the socket connection is closed. The method 200 ends at step 255.

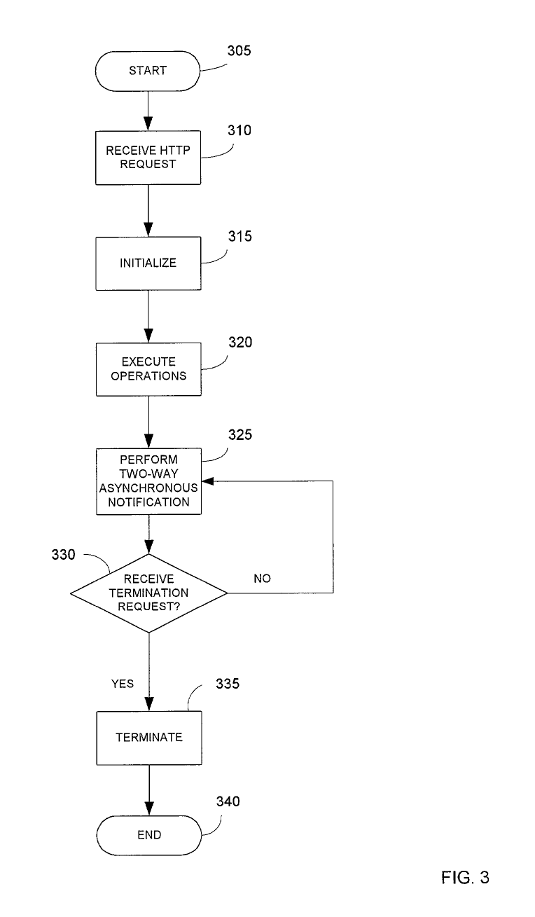

FIG. 3 shows a method 300 by which a CGI performs operations to maintain two-way asynchronous communications with the client. At step 305 the process 300 starts, whereby the CGI is ready to be initialized if not already initialized by the web server residing on the host. At step 310, the CGI receives an HTTP request from the web server that has been sent from a client. The HTTP request is comprised of an HTTP request header that tasks the web server to execute the CGI for performing specific operations. At step 315, the CGI is initialized.

The operations that comprise the CGI are executed at step 320. In an embodiment, the operations include the performance of maintaining two-way asynchronous communications to the client at step 325. The communications are persistently maintained to enable the receiving and processing of information from the client, and the construction and communication information to the client. The operations are continued until a termination request is received at step 330. The termination request can be generated in response to the client closing the client-side component of the socket connection. Upon termination, at step 335 the method 300 ends at step 340.

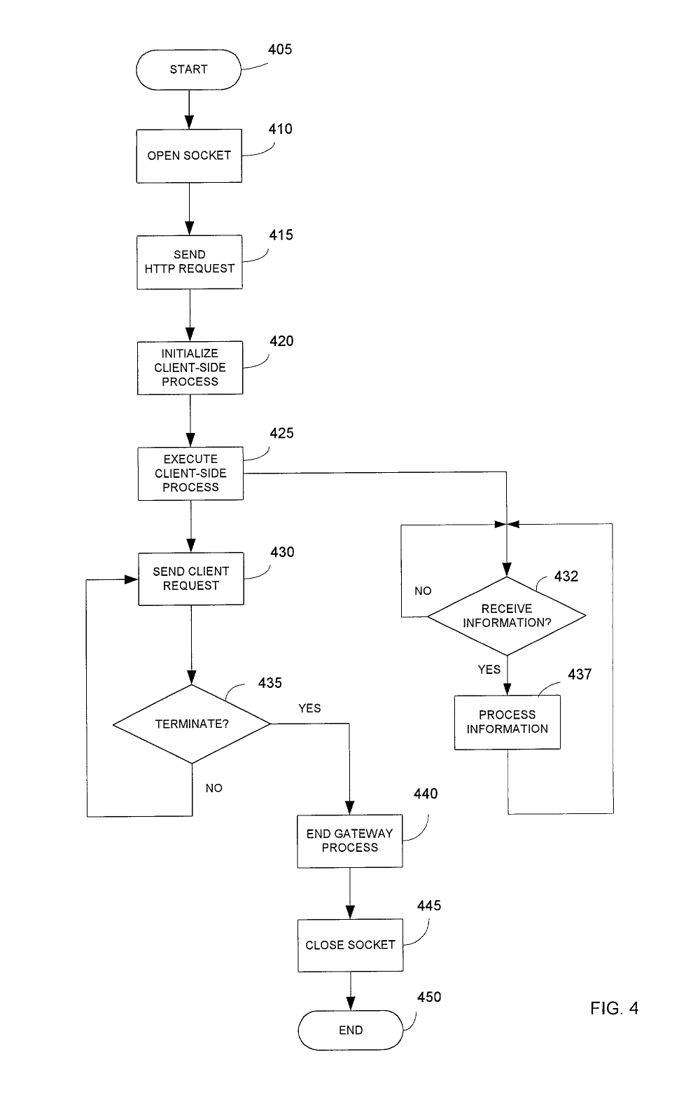

Referring now to FIG. 4, there is shown a method 400 for maintaining two-way asynchronous communication. The method 400 begins at step 405, in which a client is operational and seeking to establish communications with a web server. At step 410, the client establishes a client-side component of a socket connection with the web server, and transmits an HTTP request to the web server at step 415. The receipt of the HTTP request will cause an opening of the server-side component of the socket connection. At step 420, the client initializes a client-side process. The client-side process is preferably executed by logic either pre-existing on the client host platform or dynamically delivered to the client from the web server host. Other mechanisms of delivering the client side logic for performing the process exist. At step 425, the client side process is executed.

As executed, the client side process performs essentially two operations. In one embodiment, the operations are substantial mirrored from the first and second operations described above. In other embodiments, the client side operations are unique to particular client side logic.

In one specific exemplary embodiment, at step 430 the client sends HTTP requests to the web server according to a predetermined protocol. The protocol can include a protocol that is not compliant with HTTP. The client will continually send client requests for information to the web server until one of the requests is a termination request, determined at step 43 5 within the operation. A termination request will end the client process at step 440. Concurrently, the client-side process is configured to receive information from the web server, shown with reference to step 432. The information is preferably generated and sent from a CGI operating within or in conjunction with the web server. If no information is received, the client process will wait in a loop until information is sent via the web server. If information is received, the client will process the information at step 437.

Returning to step 440, the client process may also end by a termination signal from the web server or the CGI operating within or in conjunction with the web server. In this instance, the server side component of the socket connection is closed. Upon closing, the client side process ends, similarly to step 440. Once ended, the entire socket connection is closed at step 445.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of maintaining two-way asynchronous communication between a client and a web server using a single HTTP transaction, comprising:
communicating an HTTP request from a client to a web server, wherein the HTTP request is configured to initialize a CGI that operates within or in conjunction with the web server; and
executing operations associated with the CGI, wherein the operations are configured to perform the two-way asynchronous communication with the client until terminated by the client or the CGI.

2. The method of claim 1, wherein executing operations includes receiving and processing data from the client.

3. The method of claim 2, wherein the data is compliant with the HTTP protocol or a protocol other than HTTP.

4. The method of claim 1, wherein executing operations includes creating and communicating data from the CGI to the client.

5. The method of claim 4, wherein the data is compliant with the HTTP protocol or a protocol other than HTTP.

6. The method of claim 1, wherein the client includes client-side logic configured to perform the two-way asynchronous communication with the CGI.

7. The method of claim 6, wherein the client-side logic is pre-installed on the client.

8. The method of claim 6, wherein the client-side logic is dynamically delivered to the client from the web server.

9. A system for maintaining two-way asynchronous communication between a client and a web server using a single HTTP transaction, comprising:
means for communicating an HTTP request from a client to a web server, wherein the HTTP request is configured to initialize a CGI that operates within or in conjunction with the web server; and
means for executing operations associated with the CGI, wherein the operations are configured to perform the two-way asynchronous communication with the client until terminated by the client or the CGI.

10. The method of claim 9, wherein the executing means includes means for receiving and processing data from the client.

11. The method of claim 10, wherein the data is compliant with the HTTP protocol or a protocol other than HTTP.

12. The method of claim 9, wherein the executing means includes means for creating and communicating data from the CGI to the client.

13. The method of claim 12, wherein the data is compliant with the HTTP protocol or a protocol other than HTTP.

14. The method of claim 9, wherein the communicating means includes client-side logic configured to perform the two-way asynchronous communication with the CGI.

15. The method of claim 14, wherein the client-side logic is pre-installed on the client.

16. The method of claim 14, wherein the client-side logic is dynamically delivered to the client from the web server.

17. The method of claim 16, wherein the client-side logic is delivered in the form of a Java™ applet.

18. The method of claim 16, wherein the client-side logic is delivered in the form of Macromedia Shockwave movie.

19. The method of claim 9, wherein the CGI is a servlet.
